(19) United States
(12) Patent Application Publication
(10) Pub. No.: US 2022/0391692 A1
(43) Pub. Date: Dec. 8, 2022

(54) SEMANTIC UNDERSTANDING OF DYNAMIC IMAGERY USING BRAIN EMULATION NEURAL NETWORKS

(71) Applicant: X Development LLC, Mountain View, CA (US)

(72) Inventors: Sarah Ann Laszlo, Mountain View, CA (US); Bin Ni, Fremont, CA (US)

(21) Appl. No.: 17/341,859

(22) Filed: Jun. 8, 2021

(51) Int. Cl. G06N 3/08; G06N 3/04; G06T 7/20; G06K 9/00; G06K 9/62

(52) U.S. Cl. CPC G06N 3/08; G06N 3/0454; G06T 7/20; G06K 9/00335; G06K 9/6217; G06T 2207/20084; G06T 2207/30196; G06T 2207/10016; G06T 2207/10024; G06T 2207/20081; G06T 2207/10028; G06T 2207/10044; G01S 7/417

(57) ABSTRACT

Methods, systems, and apparatus, including computer programs encoded on a computer storage medium, for receiving sensor data generated by one or more sensors that characterizes motion of an object over multiple time steps, providing the sensor data characterizing the motion of the object to a motion prediction neural network having a brain emulation sub-network with an architecture that is specified by synaptic connectivity between neurons in a brain of a biological organism, and processing the sensor data characterizing the motion of the object using the motion prediction neural network having the brain emulation sub-network to generate a network output that defines a prediction characterizing the motion of the object.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a motion prediction system implemented as computer programs on one or more computers in one or more locations that processes sensor data captured by one or more sensors over multiple time steps using a neural network, referred to herein as a “motion prediction” neural network (also known as a “reservoir computing” neural network), to perform motion prediction tasks. The reservoir computing neural network includes a sub-network, referred to herein as a “brain emulation” sub-network, which is derived from a synaptic connectivity graph representing synaptic connectivity in the brain of a biological organism. The motion prediction neural network may be configured to process sensor data captured by one or more sensors over multiple time steps to perform any of a variety of prediction tasks, e.g., segmentation tasks, classification tasks, or regression tasks.

Throughout this specification, a “neural network” refers to an artificial neural network, i.e., that is implemented by one or more computers. For convenience, a neural network having an architecture derived from a synaptic connectivity graph may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

According to a first aspect there is a method including receiving sensor data generated by one or more sensors that characterizes motion of an object over multiple time steps, providing the sensor data characterizing the motion of the object to a motion prediction neural network having a brain emulation sub-network with an architecture that is specified by synaptic connectivity between neurons in a brain of a biological organism, where specifying the brain emulation sub-network architecture includes instantiating a respective artificial neuron in the brain emulation sub-network corresponding to each biological neuron of multiple biological neurons in the brain of the biological organism, and instantiating a respective connection between each pair of artificial neurons in the brain emulation sub-network that correspond to a pair of biological neurons in the brain of the biological organism that are connected by a synaptic connection. The methods further include processing the sensor data characterizing the motion of the object using the motion prediction neural network having the brain emulation sub-network to generate a network output that defines a prediction characterizing the motion of the object.

These and other embodiments can optionally include one or more of the following features. In some implementations, the motion prediction neural network further includes an input sub-network, where the input sub-network is configured to process the sensor data to generate an embedding of the sensor data, and where the brain emulation sub-network is configured to process the embedding of the sensor data that is generated by the input sub-network.

In some implementations, the motion prediction neural network further includes an output sub-network, where the output sub-network is configured to process an output generated by the brain emulation sub-network to generate the prediction characterizing the motion of the object.

In some implementations, a prediction characterizing the motion of the object includes a tracking prediction that tracks a location of the object over the multiple time steps. The prediction characterizing the motion of the object can predict a future motion of the object at one or more future time steps. In one example, a prediction characterizing the motion of the object can predict a future location of the object at a future time step. In another example, a prediction characterizing the motion of the object can predict whether the object will collide with another object at a future time step.

In some implementations, the sensor data characterizes motion of a person over the multiple time steps. The prediction characterizing the motion of the object can be a gesture recognition prediction that predicts one or more gestures made by the person.

In some implementations, processing the sensor data using the motion prediction neural network having the brain emulation sub-network is performed by an onboard computer system of a device. In some implementations, the methods further include providing the prediction characterizing the motion of the object to a control unit of the device, where the control unit of the device generates control signals for operation of the device.

In some implementations, sensor data includes video data including multiple frames characterizing the motion of the object over the multiple time steps. The prediction characterizing the motion of the object over the multiple time steps can include a tracking prediction that includes data defining, for each frame, a predicted location of the object in the frame. The methods can further include a pre-processing step prior to providing the video data to the motion prediction neural network, where the pre-processing step includes a color correction to each of the multiple frames of the video data.

In some implementations, sensor data includes spectrograms generated utilizing a radar microarray of sensors or light detector and ranging (LiDAR) techniques.

In some implementations, specifying the brain emulation sub-network architecture further includes, for each pair of artificial neurons in the brain emulation sub-network that are connected by a respective connection: instantiating a weight value for the connection based on a proximity of a pair of biological neurons in the brain of the biological organism that correspond to the pair of artificial neurons in the brain emulation sub-network, where the weight values of the brain emulation sub-network are static during training of the motion prediction neural network.

In some implementations, specifying the brain emulation sub-network architecture further includes specifying a first brain emulation neural sub-network selected to perform contour detection to generate a first alternative representation of the sensor data, and specifying a second brain emulation neural sub-network selected to perform motion prediction to generate a second alternative representation of the sensor data.

In some implementations, the motion prediction neural network is a recurrent neural network and wherein processing the sensor data characterizing the motion of the object using the motion prediction neural network includes, for each time step after a first time step of the multiple time steps: processing sensor data for the time step and data generated by the motion prediction neural network for a previous time step to update a hidden state of the recurrent neural network.

According to another aspect there are provided one or more non-transitory computer storage media storing instructions that when executed by one or more computers cause the one or more computers to perform the operations of the systems described herein.

According to another aspect there is provided a system comprising one or more computers and one or more storage devices storing instructions that when executed by the one or more computers cause the one or more computers to perform the methods described herein.

Particular embodiments of the subject matter described in this specification can be implemented so as to realize one or more of the following advantages.

An advantage of this technology is that future motion of an object can be predicted utilizing a built-in object permanence of the brain emulation neural network. Future motion prediction can be utilized to improve speed of gesture recognition, object motion tracking and prediction, collision avoidance, etc., while maintaining a significant (e.g., two-fold) reduction in power consumption. A reduction in power consumption can reduce weight/size requirements associated with onboard power supplies, e.g., batteries, power converters, and/or renewable power sources, such that an overall weight and/or size of a device can be reduced. For example, a device with profile limitations and/or weight limitations (e.g., a smart thermostat, drone, etc.) can limit a size/weight of an onboard power supply as well as a size/weight of an onboard computer.

Utilizing a reservoir computing neural network that includes a brain emulation sub-network that is selected for its effectiveness at performing particular tasks, e.g., detecting lines/edges, can reduce an amount of time utilized by the reservoir computing neural network to generate a prediction.

The reservoir computing neural network can achieve the advantages of lower latency in generating predictions and lower power consumption because it includes a brain emulation sub-network. The brain emulation sub-network leverages an architecture and weight values derived from a biological brain to enable the reservoir computing neural network to achieve an acceptable performance while occupying less space in memory and performing fewer arithmetic operations than would be required by other neural networks, e.g., with hand-engineered architectures or learned parameter values.

The motion prediction system described in this specification can process sensor data, e.g., video data, point cloud data, etc., captured by one or more sensors (e.g. a camera, a microarray of radar sensors, etc.) using the motion prediction neural network to generate a prediction characterizing the sensor data, e.g., a segmentation of multiple frames of a video or multiple sets of point cloud data collected over several time steps that identify an object of interest, e.g., to track motion of the object through the multiple frames (or point cloud data sets) or predict a gesture being made by the object. Predictions generated by the motion prediction system can include object motion predictions as well as object and/or motion categorization, such that the movement of an object over multiple time steps (e.g., a hand performing a gesture) can be recognized more quickly (i.e., without a complete gesture) and/or more accurately (i.e., compensating for variations in the movements performed, compensating for missing and/or noisy data, etc.).

The motion prediction neural network includes one or more brain emulation sub-networks that are each derived from a synaptic connectivity graph representing synaptic connectivity in the brain of a biological organism. The brain of the biological organism may be adapted by evolutionary pressures to be effective at solving certain tasks. For example, in contrast to many conventional computer vision techniques, a biological brain may process visual (image) data to generate a robust representation of the visual data that may be insensitive to factors such as the orientation and size of elements (e.g., objects) characterized by the visual data. The brain emulation sub-network may inherit the capacity of the biological brain to effectively solve tasks (in particular, object recognition tasks and motion prediction tasks), and thereby enable the motion prediction system to perform object identification tasks and motion prediction processing tasks more effectively, e.g., with higher accuracy. Moreover, the brain emulation sub-network may inherit the capacity of the biological brain to perform object permanence tasks (e.g., determine a future location of an object when the object is partially or fully obscured by another object).

According to some embodiments, the motion prediction system may generate pixel-level segmentations of frames from a video or sets of point cloud data collected over multiple time steps, i.e., that can identify each pixel of the frame or point of the point cloud data as being included in a respective category. In contrast, a person may manually label the positions of entities (e.g., a ball, vehicle, pedestrian) in a frame, e.g., by drawing a bounding box around the entity. The more precise, pixel-level segmentations generated by the motion prediction system may facilitate more effective downstream processing of the frame segmentations, for example, to track motion of an object through multiple frames of a video, recognize a gesture in a video, etc.

According to some embodiments, the motion prediction system can processing input sensor data over multiple time steps to perform multiple tasks utilizing multiple brain emulation sub-networks that are each selected to perform a combination of tasks related to object detection, planning (e.g., course correction for self), and prediction (for other objects in motion) simultaneously and in real-time.

The brain emulation sub-network of the reservoir computing neural network may have a very large number of parameters and a highly recurrent architecture, i.e., as a result of being derived from a synaptic connectivity graph representing synaptic connectivity in the brain of a biological organism. Therefore, training the brain emulation sub-network using machine learning techniques may be computationally-intensive and prone to failure. Rather than training the brain emulation sub-network, the motion prediction system may determine the parameter values of the brain emulation sub-network based on the predicted strength of connections between corresponding neurons in the biological brain. The strength of the connection between a pair of neurons in the biological brain may characterize, e.g., the amount of information flow through a synapse connecting the neurons. In this manner, the motion prediction system may harness the capacity of the brain emulation sub-network, e.g., to generate representations that are effective for object recognition tasks or that are effective for motion prediction, without requiring the brain emulation sub-network to be trained. By refraining from training the brain emulation sub-network, the motion prediction system may reduce consumption of computational resources, e.g., memory and computing power, during training of the reservoir computing neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example data flow diagram for generating a synaptic connectivity graph representing synaptic connectivity between neurons in the brain of a biological organism.

FIGS. 2A-2C show example motion prediction systems.

FIGS. 3A-3C show examples of sensor data capturing motion of objects.

FIG. 4 shows an example architecture selection system for generating a brain emulation neural network.

FIG. 5 is a flow diagram of an example process for processing sensor data using a motion prediction neural network to generate a prediction characterizing the sensor data.

FIG. 6 is a block diagram of an example computer system.

Like reference numbers and designations in the various drawings indicate like elements.

### DETAILED DESCRIPTION

Dynamic data (e.g., video, point cloud data, radar data, LIDAR data, etc.) of an object in motion can be processed by a motion prediction neural network to generate a prediction of the motion of the object (e.g., position, vector field, etc.). The dynamic data includes multiple frames, point cloud data sets, or spectrograms, across multiple time steps capturing the object and can be provided to an input sub-network of the motion prediction neural network to generate an embedded tensor (e.g., vector) of the dynamic data. The embedded tensor is provided to the brain emulation neural network that is suitable for predicting motion and/or object permanence. The output of the motion prediction neural network including one or more brain emulation sub-networks can define a prediction for a next location of the object and/or a vector field for the object. In some embodiments, predicting a next location of an object (e.g., a hand or finger) can be utilized to perform gesture recognition, where the output of the motion prediction neural network including one or more brain emulation sub-networks is utilized to recognize a gesture performed by the object, for example, by classifying a gesture performed over the multiple frames or recognizing characters formed by the object (e.g., letters being spelled out).

In some embodiments, a system can include multiple brain emulation neural networks arranged in any appropriate configuration, e.g., in a parallel configuration, in a sequential configuration, or a combination thereof. Different brain emulation neural networks can be effective at performing different tasks, e.g., one can be selected for generating data representations robust to noise, another can be selected to perform geometric/physical reasoning for gesture recognition or motion prediction. In one example, a brain emulation neural network can be utilized to categorize the dynamic data (e.g., frames of a video, point cloud data set, spectrograms of radar data), into shape categories (e.g., to detect lines, angles, contours, etc.). In another example, a brain emulation neural network can be utilized to generate a prediction of a next position of an object, force vector, or vector field for the object in a next time step.

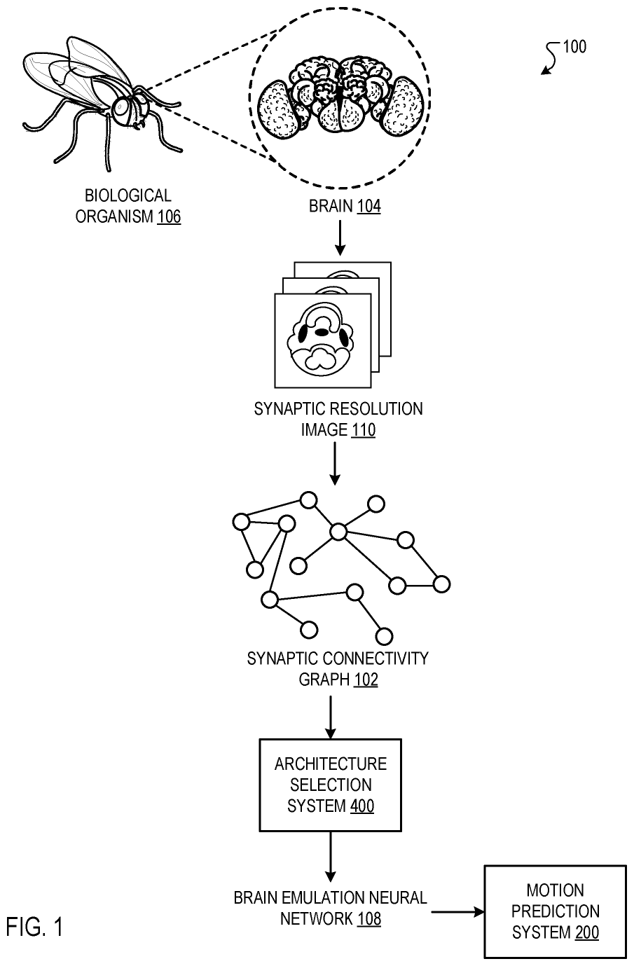

FIG. 1 shows an example data flow diagram 100 for generating a synaptic connectivity graph 102 representing synaptic connectivity between neurons in the brain 104 of a biological organism 106. As used throughout this document, a brain may refer to any amount of nervous tissue from a nervous system of a biological organism, and nervous tissue may refer to any tissue that includes neurons (i.e., nerve cells). The biological organism 106 may be, e.g., a worm, a fly, a mouse, a cat, or a human.

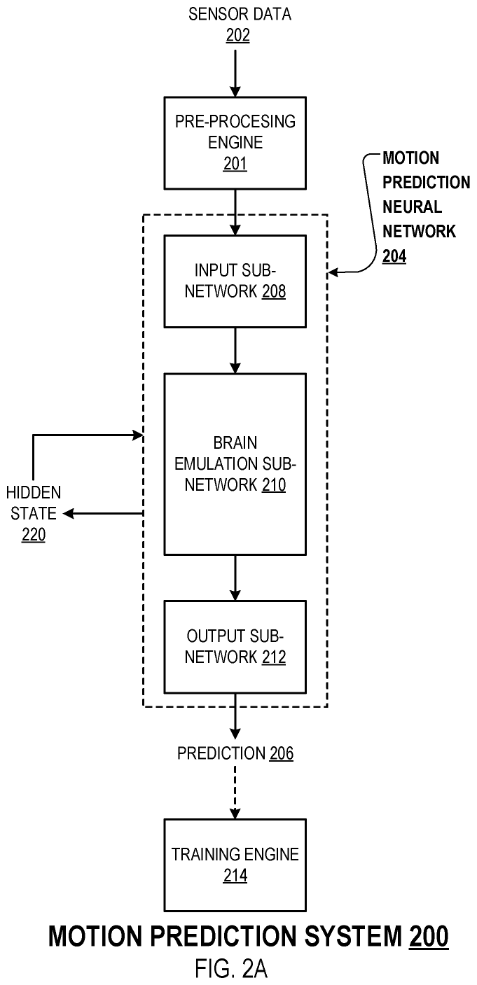

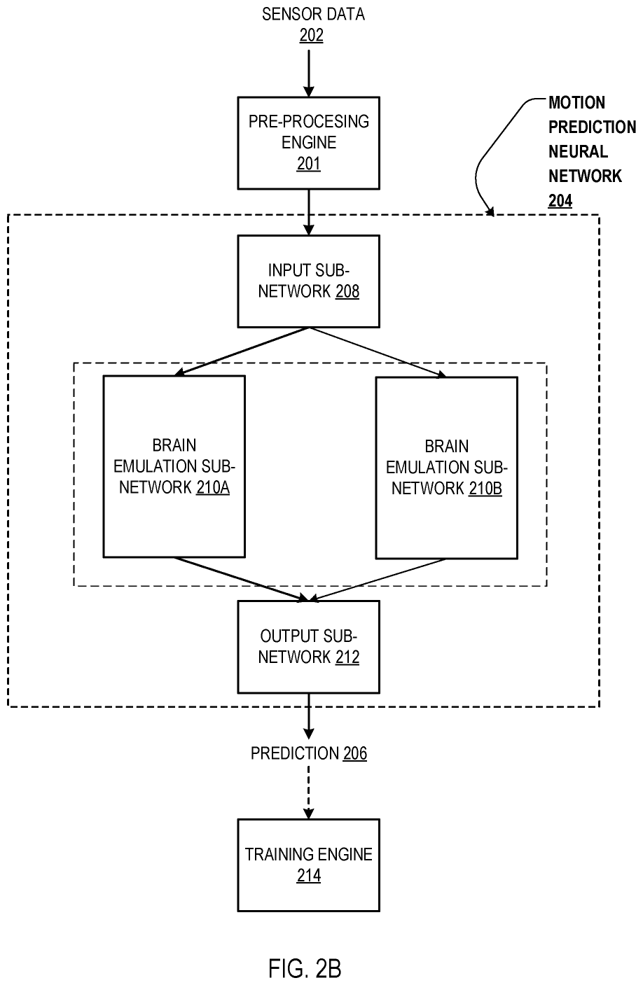

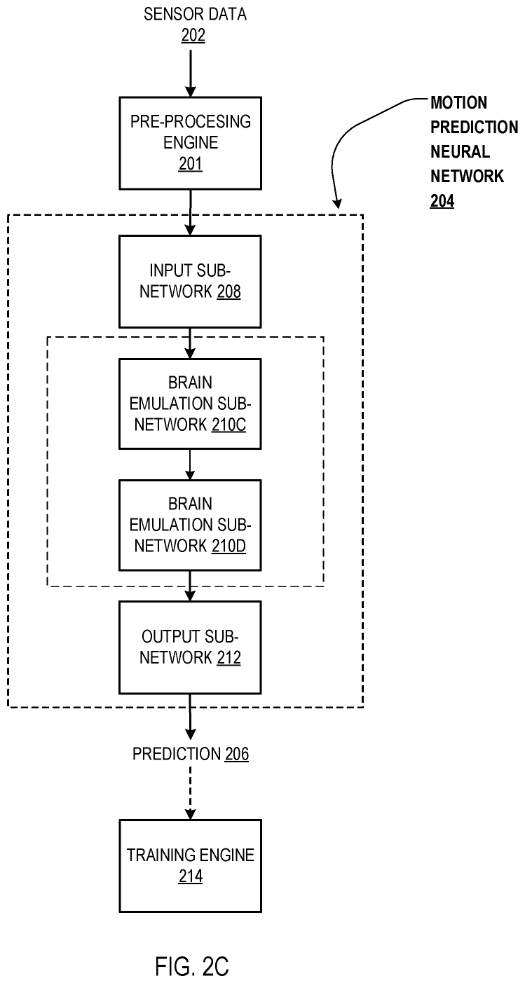

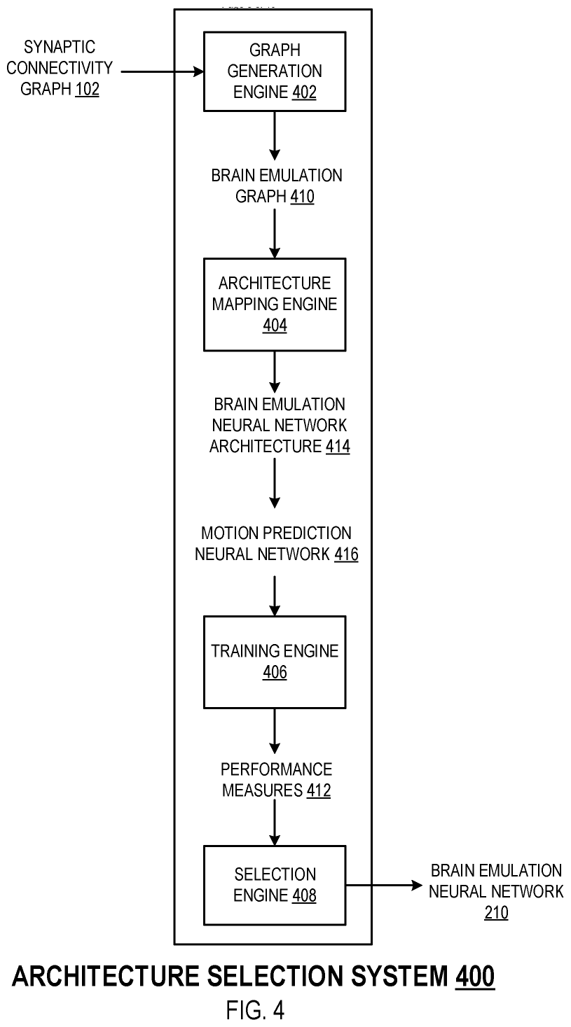

An architecture selection system 400 processes the synaptic connectivity graph 102 to generate a brain emulation neural network 108, and a motion prediction system 200 uses the brain emulation neural network for processing sensor data. An example motion prediction system 200 is described in more detail with reference to FIGS. 2A-2C, and an example architecture selection system 400 is described in more detail with reference to FIG. 4.

An imaging system may be used to generate a synaptic resolution image 110 of the brain 104. An image of the brain 104 may be referred to as having synaptic resolution if it has a spatial resolution that is sufficiently high to enable the identification of at least some synapses in the brain 104. Put another way, an image of the brain 104 may be referred to as having synaptic resolution if it depicts the brain 104 at a magnification level that is sufficiently high to enable the identification of at least some synapses in the brain 104. The image 110 may be a volumetric image, i.e., that characterizes a three-dimensional representation of the brain 104. The image 110 may be represented in any appropriate format, e.g., as a three-dimensional array of numerical values.

The imaging system may be any appropriate system capable of generating synaptic resolution images, e.g., an electron microscopy system. The imaging system may process “thin sections” from the brain 104 (i.e., thin slices of the brain attached to slides) to generate output images that each have a field of view corresponding to a proper subset of a thin section. The imaging system may generate a complete image of each thin section by stitching together the images corresponding to different fields of view of the thin section using any appropriate image stitching technique. The imaging system may generate the volumetric image 110 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system may be used to process the synaptic resolution image 110 to generate the synaptic connectivity graph 102. The synaptic connectivity graph 102 specifies a set of nodes and a set of edges, such that each edge connects two nodes. To generate the graph 102, the graphing system identifies each neuron in the image 110 as a respective node in the graph, and identifies each synaptic connection between a pair of neurons in the image 110 as an edge between the corresponding pair of nodes in the graph.

The graphing system may identify the neurons and the synapses depicted in the image 110 using any of a variety of techniques. For example, the graphing system may process the image 110 to identify the positions of the neurons depicted in the image 110, and determine whether a synapse connects two neurons based on the proximity of the neurons (as will be described in more detail below). In this example, the graphing system may process an input including: (i) the image, (ii) features derived from the image, or (iii) both, using a machine learning model that is trained using supervised learning techniques to identify neurons in images. The machine learning model may be, e.g., a convolutional neural network model or a random forest model. The output of the machine learning model may include a neuron probability map that specifies a respective probability that each voxel in the image is included in a neuron. The graphing system may identify contiguous clusters of voxels in the neuron probability map as being neurons.

Optionally, prior to identifying the neurons from the neuron probability map, the graphing system may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system to generate the neuron probability map may be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input may be a synaptic resolution image of a brain, and the target output may be a “label map” that specifies a label for each voxel of the image indicating whether the voxel is included in a neuron. The target outputs of the training examples may be generated by manual annotation, e.g., where a person manually specifies which voxels of a training input are included in neurons.

Example techniques for identifying the positions of neurons depicted in the image 110 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system may identify the synapses connecting the neurons in the image 110 based on the proximity of the neurons. For example, the graphing system may determine that a first neuron is connected by a synapse to a second neuron based on the area of overlap between: (i) a tolerance region in the image around the first neuron, and (ii) a tolerance region in the image around the second neuron. That is, the graphing system may determine whether the first neuron and the second neuron are connected based on the number of spatial locations (e.g., voxels) that are included in both: (i) the tolerance region around the first neuron, and (ii) the tolerance region around the second neuron. For example, the graphing system may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron may be specified as the set of spatial locations in the image that are either: (i) in the interior of the neuron, or (ii) within a predefined distance of the interior of the neuron.

The graphing system may further identify a weight value associated with each edge in the graph 102. For example, the graphing system may identify a weight for an edge connecting two nodes in the graph 102 based on the area of overlap between the tolerance regions around the respective neurons corresponding to the nodes in the image 110. The area of overlap may be measured, e.g., as the number of voxels in the image 110 that are contained in the overlap of the respective tolerance regions around the neurons. The weight for an edge connecting two nodes in the graph 102 may be understood as characterizing the (approximate) strength of the connection between the corresponding neurons in the brain (e.g., the amount of information flow through the synapse connecting the two neurons).

In addition to identifying synapses in the image 110, the graphing system may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system determines the directions of the synapses in the image 110, the graphing system may associate each edge in the graph 102 with direction of the corresponding synapse. That is, the graph 102 may be a directed graph. In other implementations, the graph 102 may be an undirected graph, i.e., where the edges in the graph are not associated with a direction.

The graph 102 may be represented in any of a variety of ways. For example, the graph 102 may be represented as a two-dimensional array of numerical values, referred to as an “adjacency matrix”, with a number of rows and columns equal to the number of nodes in the graph. The component of the array at position (i,j) may have value 1 if the graph includes an edge pointing from node i to node j, and value 0 otherwise. In implementations where the graphing system determines a weight value for each edge in the graph 102, the weight values may be similarly represented as a two-dimensional array of numerical values. More specifically, if the graph includes an edge connecting node i to node j, the component of the array at position (i,j) may have a value given by the corresponding edge weight, and otherwise the component of the array at position (i,j) may have value 0.

The architecture selection system 400 processes the synaptic connectivity graph 102 to generate a brain emulation neural network 108. The architecture selection system may determine the neural network architecture of the brain emulation neural network by searching a space of possible neural network architectures. The architecture selection system 400 may seed (i.e., initialize) the search through the space of possible neural network architectures using the synaptic connectivity graph 102 representing synaptic connectivity in the brain 104 of the biological organism 106. An example architecture selection system 400 is described in more detail with reference to FIG. 4.

Example techniques for identifying portions of a brain of the biological organism that are involved in object permanence (i.e., the dorsolateral prefrontal cortex in rhesus monkeys) are described with reference to: Diamond, A., & Goldman-Rakic, P. S.: “Comparative development in human infants and infant rhesus monkeys of cognitive functions that depend on prefrontal cortex,” Society for Neuroscience Abstracts, 12, 742 (1986), and Diamond, A., Zola-Morgan, S., & Squire, L. R.: “Comparison of human infants and rhesus monkeys on Piaget's AB task: Evidence for dependence on dorsolateral prefrontal cortex,” Experimental Brain Research, 74, 24-40. (1989).

The motion prediction system 200 uses the brain emulation neural network 108 to process sensor data to generate predictions, as will be described in more detail next.

FIGS. 2A-2C show example motion prediction systems implemented as computer programs on one or more computers in one or more locations in which the systems, components, and techniques described below are implemented. A motion prediction system can be implemented as computer programs on one or more computers located onboard a device, e.g., a mobile phone, table, “smart” appliance (e.g., thermostat, refrigerator, television, etc.), or the like, on one or more cloud-based servers (i.e., such that the device provides sensor data to the system in real-time to the cloud-based servers via a network for processing and receives back results of the processing), or a combination thereof. In one example, a motion prediction system is implemented as computer programs on one or more single-board computers, e.g., one or more Raspberry Pi boards or the like, located on a device.

Sensor data 202 can be collected over multiple time steps, where each time step of sensor data (e.g., a frame of a video, a spectrogram, point cloud data, etc.) can include a representation of an object within the sensor data at the time step. In other words, a sequence of sensor data (e.g., sequential frames of a video, a sequence of spectrograms) can depict a motion of an object over the multiple time steps.

As depicted in FIG. 2A system 200 is configured to process sensor data 202 collected over multiple time steps using a motion prediction neural network 204 to generate a prediction 206 characterizing the sensor data 202.

Sensor data 202 may be captured by a sensor using any of a variety of sensor collection modalities. For example, the sensor data 202 may be video data including a sequence of multiple frames captured over multiple time steps by a camera, for example, a visible light camera, an infrared camera, or a hyperspectral camera. The sensor data 202 may be represented, e.g., as an array of numerical values.

In some implementations, the system 200 can be configured to process sensor data 202 that includes point cloud data generated, for example, by one or more light detecting and ranging (LiDAR) sensors and/or one or more radio detecting and ranging (RADAR) sensors. Processing by the system 200 of the point cloud data can proceed similarly as described with reference to the processing of video data.

In some implementations, the system 200 can be configured to process sensor data 202 that includes spectrograms generated, for example, utilizing a radar microarray of sensors or light detector and ranging (LiDAR) techniques. Processing by the system 200 of the spectrogram data can proceed similarly as described with reference to the processing of video data.

In some implementations, a motion prediction neural network 204 includes: (i) an input sub-network 208, (ii) a brain emulation sub-network 210, and (iii) an output sub-network 212, each of which will be described in more detail next. Throughout this specification, a “sub-network” refers to a neural network that is included as part of another, larger neural network. Motion prediction neural network 204 can include various architectures, including, for example, a recursive neural network and/or “wide” neural network including multiple parallel or sequential brain emulation sub-networks 210, as will be described in more detail with reference to FIGS. 2B and 2C below.

Referring back to FIG. 2A, in some implementations, the system 200 includes a pre-processing engine 201 to perform pre-processing of the sensor data 202 prior to processing by the motion prediction neural network 204.

In some implementations, sensor data 202 includes multiple frames of a video such that pre-processing engine 201 is configured to receive the video data as input and perform object recognition operations on frames of the video data to generate modified frames as output to the motion prediction neural network 204. In some implementations, operations performed on the video data by the pro-processing engine 201 include a color correction operation.

A color correction operation can be implemented to maximize an amount of gain between an object of interest and a surrounding environment. Color correction can be performed, for example, using a gamma correction process. Other color correction operations can include, for example, performing a greyscale operation, performing a hyper-parameter optimization (e.g., to determine an optimized set of red/green/blue ratios that are utilized for color correction, or the like.

In some implementations, alternative and/or additional pre-processing steps can be applied to sensor data 202 by the system, for example, down-sampling of video data (e.g., down-sampling from 60 Hz to 30 Hz), cropping the video data (e.g., removing edges of frame not including relevant objects), and/or edge enhancement techniques (e.g., to enhance contours/lines within the sensor data).

In some implementations, sensor data 202 includes point cloud data (e.g., LiDAR point cloud data) collected over multiple time steps such that pre-processing engine 201 is configured to receive the point cloud data and generate spectrograms including, for example, 4 or 5 dimensions (e.g., frequency, time, amplitude, and spatial coordinates) for multiple time steps of the point cloud data.

In some implementations, sensor data 202 includes radar data such that the pre-processing engine 201 is configured to receive radar data and apply radar digital signal processing (DSP) techniques to the radar data. In some implementations radar data provided to the motion prediction system 200 can be low resolution, high noise, and/or include a large volume of data as result of a high collection rate (e.g., sampling rates over 1000 Hz). After applying radar DSP techniques to the radar data, the processed radar data can be displayed as an image, where the image composition includes a vertical axis of each image representing range, or radial distance, from the sensor, increasing from top to bottom. A horizontal axis can represent velocity toward or away from the sensor, with zero at the center, where negative velocities correspond to approaching targets on the left, and positive velocities correspond to receding targets on the right. Energy received by the radar can be mapped into these range-velocity dimensions and represented by the intensity of each pixel. As such, strongly reflective targets can be brighter relative to the surrounding noise floor compared to weakly reflective targets.

In some implementations, one or more of the functions described with reference to the pre-processing engine 201 can be (implicitly) performed by the input sub-network 208 of the motion prediction neural network 204.

The output from the pre-processing engine 201 is provided as input to the input sub-network 208. The input sub-network 208 is configured to process the output of the pre-processing engine 201 to generate an embedding of the output, i.e., a representation of the sensor data 202 as an ordered collection of numerical values, e.g., a vector, tensor, or matrix of numerical values. The input sub-network may have any appropriate neural network architecture that enables it to perform its described function, e.g., a neural network architecture that includes a single fully-connected neural network layer.

The brain emulation sub-network 210 is configured to process the embedding of the sensor data 202 (i.e., that is generated by the input sub-network) to generate an alternative representation of the sensor data, e.g., as an ordered collection of numerical values, e.g., a vector, tensor, or matrix of numerical values. The architecture of the brain emulation sub-network 210 is derived from a synaptic connectivity graph representing synaptic connectivity in the brain of a biological organism. The brain emulation sub-network 210 may be generated, e.g., by an architecture selection system, which will be described in more detail with reference to FIG. 4.

The output sub-network 212 is configured to process the alternative representation of the sensor data (i.e., that is generated by the brain emulation sub-network 210) to generate the prediction 206 characterizing the sensor data 202. The output sub-network 212 may have any appropriate neural network architecture that enables it to perform its described function, e.g., a neural network architecture that includes a single fully-connected layer.

In some cases, the brain emulation sub-network 210 may have a recurrent neural network architecture, i.e., where the connections in the architecture define one or more “loops.” More specifically, the architecture may include a sequence of components (e.g., artificial neurons, layers, or groups of layers) such that the architecture includes a connection from each component in the sequence to the next component, and the first and last components of the sequence are identical. In one example, two artificial neurons that are each directly connected to one another (i.e., where the first neuron provides its output to the second neuron, and the second neuron provides its output to the first neuron) would form a recurrent loop.

A recurrent brain emulation sub-network may process an embedding of sensor data (i.e., generated by the input sub-network) over multiple internal time steps to generate a respective alternative representation of the sensor data at each internal time step. In particular, at each internal time step, the brain emulation sub-network may process: (i) the embedding of sensor data, and (ii) any outputs generated by the brain emulation sub-network at the preceding internal time step, to generate the alternative representation of the sensor data for the internal time step. The motion prediction neural network 204 may provide the alternative representation of the sensor data generated by the brain emulation sub-network at the final internal time step as the input to the output sub-network 212. The number of internal time steps over which the brain emulation sub-network 210 processes the sensor data embedding may be a predetermined hyper-parameter of the motion prediction system 200.

In some implementations, in addition to processing the alternative representation of the sensor data 202 generated by the output layer of the brain emulation sub-network 210, the output sub-network 212 may additionally process one or more intermediate outputs of the brain emulation sub-network 210. An intermediate output refers to an output generated by a hidden artificial neuron of the brain emulation sub-network, i.e., an artificial neuron that is not included in the input layer or the output layer of the brain emulation sub-network.

The motion prediction neural network 204 can be configured to process sensor data (e.g., video frames, radar spectrograms, or point clouds) captured over a sequence of time steps in a variety of possible ways. For example, the motion prediction neural network 204 can be a feed-forward neural network that is configured to simultaneously process sensor data captured over a predefined number of time steps, e.g., 10 time steps, to generate a network output characterizing the sensor data. As another example, the motion prediction neural network can be a recurrent neural network that is configured to process sensor data sequentially, e.g., by processing sensor data one time step at a time. More specifically, the motion prediction neural network can maintain a hidden state 220, e.g., represented as an ordered collection of numerical values, e.g., a vector or matrix of numerical values. At each time step, the motion prediction neural network can update its hidden state based on: (i) the sensor data for the time step, and (ii) data generated by the motion prediction neural network at the preceding time step (e.g., the hidden state at the preceding time step, or the prediction 206 generated by the motion prediction neural network at the preceding time step).

Example architectures of recurrent neural networks that include brain emulation sub-networks are described in more detail with reference to U.S. patent application Ser. No. 17/119,288, which is incorporated herein by reference. Generally, the motion prediction neural network 204 can include any appropriate recurrent neural network layers, e.g., long short-term memory neural network (LSTM) layers.

In one example, as described above, sensor data 202 can be a video including multiple frames sequentially captured over multiple time steps by a camera, where the multiple frames can depict an object in motion (e.g., a ball in motion through multiple frames, a vehicle in motion through multiple frames, a hand performing a gesture through multiple frames). An input to the motion prediction neural network 204 can include respective representation of the multiple frames of the video, where the frames of the video are provided in a sequential order to the motion prediction neural network (i.e., provided according to the time step at which they were captured).

In another example, sensor data 202 can be spectrograms (or point cloud data sets) sequentially captured over multiple time steps (e.g., by a microarray of radar devices), where the multiple spectrograms can depict a gesture being performed across the multiple spectrograms. An input to the motion prediction neural network 204 can include respective representation of the multiple spectrograms, where the spectrograms are provided in a sequential order to the motion prediction neural network (i.e., provided according to the time step at which they were captured).

In some implementations, motion prediction system 200 can include multiple motion prediction neural networks 204 including sandwiched layers between the multiple motion prediction neural networks 204, where the multiple motion prediction neural networks 204 are trained end-to-end.

In some implementations, motion prediction system 200 can include separate motion prediction neural networks 204 trained individually, where output from one is provided to next motion prediction neural network 204, such that no end-to-end training or sandwiching of trained layers is performed in-between the different brain emulation sub-networks 210.

In some implementations, motion prediction system 200 includes a wide network where copies of a same input (e.g., sensor data 202 or embedded sensor data 202) are provided as input to multiple modules each including a motion prediction neural network 204, and where the output of each module is combined to integrate the information processed by each of the modules.

As depicted in FIGS. 2B and 2C, motion prediction system can include multiple brain emulation sub-networks. As depicted in FIG. 2B, the multiple brain emulation sub-networks 210A, 210B can be arranged to each receive an input from the input sub-network 208, e.g., to perform parallel processing of the embedded sensor data 202. As depicted in FIG. 2C, the multiple emulation sub-networks 210C, 210D can be arranged in series, such that an output of a first brain emulation sub-network can be provided as input to a second brain emulation sub-network. Each brain emulation sub-network can be generated, e.g., by an architecture selection system, to be selected to perform a particular task, e.g., object recognition, motion prediction, etc., which will be described in more detail with reference to FIG. 4. The multiple brain emulation sub-networks 210A and 210B, or 210C and 210D can act in parallel and in communication with each other to accomplish a combination of tasks.

Generally, the example architectures of the motion prediction neural network that are described with reference to FIGS. 2A-C are provided for illustrative purposes only, and other architectures of the motion prediction neural network are possible. For example, the motion prediction neural network may include a sequence of multiple different brain emulation sub-networks, e.g., each generated by the architecture selection system described with reference to FIG. 4. In this example, the brain emulation sub-networks may be interleaved with sub-networks having parameter values that are trained during the training of the motion prediction neural network, e.g., in contrast to the parameter values of the brain emulation sub-networks. Generally, a motion prediction neural network includes: (i) one or more brain emulation sub-networks having parameter values derived from a synaptic connectivity graph, and (ii) one or more trainable sub-networks. The brain emulation sub-networks and the trainable sub-networks may be connected in any of a variety of configurations.

The motion prediction neural network 204 may be configured to generate any of a variety of predictions 206 corresponding to the sensor data 202. Prediction 206 generated by motion prediction neural network 204 can be provided as an output of the motion prediction system 200 and/or fed back into the motion prediction neural network 204 as an input for a next time step prediction. A few examples of predictions 206 that may be generated by the motion prediction neural network 204 are described in more detail next.

In one example, the motion prediction neural network 204 may be configured to generate a tracking prediction 206, at each time step of multiple time steps, that defines a segmentation in the sensor data 202 of a location of an object of interest at each time step. The segmentation of the sensor data 202 may include, for each pixel of an image or for each point of a point cloud data set, a respective score defining a likelihood that the pixel or point is included within an object of interest. For example, a score can be assigned to each pixel or point that defines a likelihood that the pixel or point is included in a ball, vehicle, person (e.g., pedestrian), drone, etc. The respective scores generated at each of multiple time steps that define a likely location of the object of interest over multiple time steps can be utilized to track the movement of the object through the multiple time steps of the sensor data.

In another example, the motion prediction neural network 204 may be configured to generate a tracking prediction 206 that, at each time step of multiple time steps, defines a bounding box enclosing an object of interest at each time step. For example, a set of predictions corresponding to the multiple time steps can each include a bounding box enclosing the object (e.g., a human) within the sensor data (e.g., a respective frame of a video).

In another example, the motion prediction neural network 204 may be configured to generate a prediction 206 that categorizes an object or entity detected within the sensor data 202 over multiple time steps into multiple possible categories. The categorization of the sensor data 202 may include, at each time step of multiple time steps, assigning a respective score for each possible category that defines a likelihood that the detected object is included in the possible category. For example, the set of possible categories may include multiple different gesture categories (e.g., “swipe left”, “swipe up”, “square”, “select”, etc.). In another example, the set of possible categories can additionally or alternatively include multiple different letter and/or number categories (e.g., “A,” “B”, “C”, “1”, “2”, etc.). In another example, the set of possible categories can additionally or alternatively include multiple different objects of interest, e.g., “tree,” “road,” “power line”, or (more generically) “hazard,” and a “default” category (e.g., such that each pixel that is not included in any other category may be understood as being included in the default category).

In another example, the motion prediction neural network 204 may be configured to generate a prediction 206 that defines a classification of the sensor data 202 into multiple possible classes. The classification of the sensor data may include a respective score for each possible class that defines a likelihood that the sensor data is included in the class. In one example, the possible classes may include: (i) a first class indicating that at least a threshold area of the sensor data is occupied by a certain category of entity, and (ii) a second class indicating that less than a threshold area of the sensor data is occupied by the category of entity. The category of entity may be, for example, multiple gestures (e.g., hand wave, “circle,” “selection”, “swipe,” etc.), multiple different objects of interest (e.g., a ball, person, vehicle, bicycle, etc.), or hazard, (e.g., power lines, roadways, trees, building, etc.) The threshold area of the sensor data 202 may be, e.g., 10%, 20%, 30%, or any other appropriate threshold area.

In another example, the motion prediction neural network 204 may be configured to generate a prediction 206 that is drawn from a continuous range of possible values, i.e., the motion prediction neural network 204 may perform a regression task. For example, the prediction 206 may define a fraction of the area of the sensor data that is occupied by a certain category of entity, e.g., a gesture, object of interest, etc. In this example, the continuous range of possible output values may be, e.g., the range [0,1].

In another example, the motion prediction neural network 204 may be configured to generate a binary prediction 206, e.g., 0/1 binary prediction, representative of a determination that a pixel or point is included in an object of interest (e.g., a human, vehicle, ball, etc.) or is included in a gesture. In other words, the motion prediction neural network 204 processes the sensor data 202 to generate either a “0” or “1” value output (or a value in the continuous range [0,1]) prediction.

In another example, the motion prediction neural network 204 may be configured to generate a prediction 206 of object motion, e.g., a likelihood that one or more pixels or points include an object of interest at a future time step, a force vector for the object of interest, vector field for the object of interest, a set of coordinates for a future position of the object of interest, whether the object of interest will overlap with another different object or not, a binary prediction (e.g., safe/unsafe, target zone/not target zone) for motion of the object of interest, etc.

In some implementations, one or more of the time steps of sensor data 202 (e.g., one or more frames of a video or one or more spectrograms or point cloud data sets at respective time steps) include an object of interest where the object of interest is partially or fully obscured. For example, an object of interest can be a ball where the ball is partially or fully obscured for at least one time step of the sensor data 202 (e.g., ball is behind another object, bounces out of the scene, etc.). The motion prediction neural network 204 may be configured to generate a prediction 206 of the hidden object in motion, e.g., a likelihood that one or more pixels or points include an object of interest at a future time step, a force vector for the object of interest, vector field for the object of interest, a set of coordinates for a future position of the object of interest, whether the object of interest will overlap with another different object or not, a binary prediction (e.g., safe/unsafe, target zone/not target zone) for motion of the object of interest, etc.

In some implementations, one or more time steps of sensor data 202 (e.g., one or more time steps of point cloud data or spectrograms, or frames of a video) include noisy and/or missing data points such that a location/trajectory of an object of interest is not clearly defined. Predictions 206 including object motion at a future time step can be utilized to “fill in” missing data from the sensor data to compensate. For example, radar spectrogram data capturing a gesture performed by a user can be noisy and/or missing data. A prediction 206 including a next position of a user's hand at a future time step can fill in missing radar spectrogram data.

As described above, multiple brain emulation sub-networks may be utilized to perform multiple parallel or sequential tasks, for example, i) object identification and ii) motion prediction at a future time step for the identified object. For example, a first task completed by a first brain emulation sub-network can include processing embedded sensor data 202 over multiple time steps to generate an intermediate output, and a second task completed by a second brain emulation sub-network can include receiving i) the embedded sensor data 202 over multiple time steps and/or ii) the intermediate output of the first brain emulation sub-network and generating a prediction of a next location of the object of interest.

The predictions 206 generated by the motion prediction neural network 204 can be used for any of a variety of purposes. A few example use cases for the predictions 206 generated by the motion prediction neural network 204 are described in more detail next.

In one example, the motion prediction neural network 204 may be configured to generate a prediction about object motion at a future time step. Based on the prediction about object motion at a future time, the motion prediction neural network 204 can be configured to identify (i.e., classify) a gesture or gesture in progress (i.e., an incompletely formed gesture) captured by the sensor data 202. For example, predictions 206 including object motion over multiple time steps can be processed, e.g., by brain emulation sub-network 210 of the motion prediction neural network 204 or output sub-network 212, to identify a gesture being performed by the user.

In another example, the motion prediction neural network 204 can be configured to identify a next location of the object of interest at a future time step, e.g., can include identifying a next point or pixel (e.g., a center point of the object of interest) at a future time step. Based on the prediction about a next location of the object of interest at a future time, the motion prediction neural network 204 can be configured to generate a confidence estimate between 0 and 1 of how likely a collision between the object of interest and a second, different object (e.g., between a vehicle and a pedestrian, between two vehicles, between two drones, between a vehicle and a building, etc.). Based on these confidence estimates, the motion prediction neural network 204 may be configured to generate a designation within the sensor data 202 as a “safe” or “unsafe” zone (e.g., for navigating a vehicle or drone), a “target zone” or “not target zone” (e.g., for a ball in motion), etc.

In some implementations, predictions 206 output by the motion prediction neural network 204 can be provided to a control unit of a device that can be utilized to generate control signals for operating the device. For example, predictions 206 can be provided to a control unit of a thermostat to generate control signals for adjusting a climate control setting, e.g., by adjusting a temperature or fan speed.

In some implementations, predictions 206 output by the motion prediction neural network 204 can include multiple different gestures, where each gesture of the multiple different gestures can be mapped to a respective action that can be implemented by a control unit of a device. For example, a swiping up/down gesture can be mapped to an increase/decrease temperature operation by a control unit of a smart thermostat. In another example, a swiping up/down gesture can be mapped to increase/decrease a volume operation of an auditory output of a digital assistant (e.g., a smart home assistant).

In some implementations, predictions 206 output by the motion prediction neural network 204 can include a sequence of predictions output by the motion prediction neural network 204, where the sequence of predictions can be, for example, a sequence of gestures performed by a user, a sequence of characters (e.g., letters, numbers, symbols) written out (e.g., in the air) by the user. For example, a user can perform a sequence of gestures/characters, e.g., to spell letters of a word, such that the motion prediction neural network 204 can generate predictions 206 at each of multiple time steps, a score distribution over the possible gestures that the user may be performing at a particular time step.

In some implementations, predictions 206 output by the motion prediction neural network 204 can be utilized by a control system of a vehicle to perform collision avoidance maneuvers and/or course correction. In one example, predictions 206 can be provided to a control unit of a drone to generate control signals for adjusting navigation of the drone (e.g., by adjusting a propeller speed/direction) to avoid a collision with another object (e.g., to avoid colliding with another drone). In yet another example, predictions 206 can be provided to a control unit of a vehicle to generate control signals for adjusting navigation of the vehicle (e.g., by adjusting a vehicle speed, steering, etc.), or to generate an alert related to a prediction (i.e., to alert a driver that a pedestrian is moving into a path of the vehicle).

In some implementations, the motion prediction neural network 204 can be configured to identify a next location of the object of interest at a future time step, where the predictions about future locations can be used to generate visualizations of the objects of interest in motion for presentation on a display. For example, a “puck tracker” for a video recording (or live broadcast) of a hockey game or a “football tracker” for a video recording (or live broadcast) of a football game.

The motion prediction system 200 may use a training engine 214 to train the motion prediction neural network 204, i.e., to enable the motion prediction neural network 204 to generate accurate predictions. The training engine 214 may train the motion prediction neural network 204 on a set of training data that includes multiple training examples, where each training example specifies: (i) sensor data, and (ii) a target prediction corresponding to the sensor data. The target prediction corresponding to the sensor data defines the prediction that should be generated by the motion prediction neural network 204 by processing the sensor data.

At each of multiple training iterations, the training engine 214 may sample a batch (i.e., set) of training examples from the training data, and process the respective sensor data included in each training example using the motion prediction neural network 204 to generate a corresponding prediction. The training engine 214 may determine gradients of an objective function with respect to the motion prediction neural network parameters, where the objective function measures an error between: (i) the predictions generated by the motion prediction neural network, and (ii) the target predictions specified by the training examples. The training engine 214 may use the gradients of the objective function to update the values of the motion prediction neural network parameters, e.g., to reduce the error measured by the objective function. The error may be, e.g., a cross-entropy error, a squared-error, or any other appropriate error. The training engine 214 may determine the gradients of the objective function with respect to the motion prediction neural network parameters, e.g., using backpropagation techniques. The training engine 214 may use the gradients to update the motion prediction neural network parameters using the update rule of a gradient descent optimization algorithm, e.g., Adam or RMSprop.

During training of the motion prediction neural network 204, the parameter values of the input sub-network 208 and the output sub-network 212 are trained, but some or all of the parameter values of the one or more brain emulation sub-networks 210 may be static, i.e., not trained. Instead of being trained, the parameter values of the one or more brain emulation sub-networks 210 may be determined from the weight values of the edges of the synaptic connectivity graph, as will be described in more detail below with reference to FIG. 4. Generally, a brain emulation sub-network may have a large number of parameters and a highly recurrent architecture as a result of being derived from the synaptic connectivity of a biological brain. Therefore training a brain emulation sub-network may be computationally-intensive and prone to failure, e.g., as a result of the parameter values of the brain emulation sub-network oscillating or diverging rather than converging to fixed values. The motion prediction neural network 204 may harness the capacity of the one or more brain emulation sub-networks, e.g., to generate respective representations that are each effective for object identification and object motion prediction, without requiring the respective brain emulation sub-networks to be trained.

The training engine 214 may use any of a variety of regularization techniques during training of the motion prediction neural network 204. For example, the training engine 214 may use a dropout regularization technique, such that certain artificial neurons of the brain emulation sub-network are “dropped out” (e.g., by having their output set to zero) with a non-zero probability p>0 each time the brain emulation sub-network processes an input. Using the dropout regularization technique may improve the performance of the trained motion prediction neural network 204, e.g., by reducing the likelihood of over-fitting. An example dropout regularization technique is described with reference to: N. Srivastava, et al.: “Dropout: a simple way to prevent neural networks from overfitting,” Journal of Machine Learning Research 15 (2014) 1929-1958. As another example, the training engine 214 may regularize the training of the motion prediction neural network 204 by including a “penalty” term in the objective function that measures the magnitude of the parameter values of the input sub-network 208, the output sub-network 212, or both. The penalty term may be, e.g., an L₁ or L₂ norm of the parameter values of the input sub-network 208, the output sub-network 212, or both.

In some cases, the values of the intermediate outputs of the one or more brain emulation sub-networks 210 may have large magnitudes, e.g., as a result of the parameter values of the brain emulation sub-network 210 being derived from the weight values of the edges of the synaptic connectivity graph rather than being trained. Therefore, to facilitate training of the motion prediction neural network 204, batch normalization layers may be included between the layers of the one or more brain emulation sub-networks 210, which can contribute to limiting the magnitudes of intermediate outputs generated by the one or more brain emulation sub-networks. Alternatively or in combination, the activation functions of the neurons of respective brain emulation sub-networks may be each selected to have a limited range. For example, the activation functions of the neurons of the one or more brain emulation sub-networks may be selected to be sigmoid activation functions with range given by [0,1].

The example architectures of the motion prediction neural network that is described with reference to FIGS. 2A-2C are provided for illustrative purposes only, and other architectures of the motion prediction neural network are possible. For example, as described above, the motion prediction neural network may include a sequence of multiple different brain emulation sub-networks, e.g., each generated by the architecture selection system described with reference to FIG. 4. In this example, the brain emulation sub-networks may be interleaved with sub-networks having parameter values that are trained during the training of the motion prediction neural network, i.e., in contrast to the parameter values of the brain emulation sub-networks. Generally, a motion prediction neural network 204 includes: (i) one or more brain emulation sub-networks having parameter values derived from a synaptic connectivity graph, and (ii) one or more trainable sub-networks. The brain emulation sub-networks and the trainable sub-networks may be connected in any of a variety of configurations.

In some implementations, multiple different brain emulation sub-networks 210 can each be selected to perform a particular task, e.g., object detection, motion prediction, etc., where the architecture selection system 400 can perform the selection of a brain emulation sub-network 210 that enables the most effective outcome for each task. For example, the multiple brain emulation sub-networks 210 can include a first brain emulation sub-network for performing object detection and a second brain emulation sub-network for performing motion prediction (i.e., for performing object permanence).

In some implementations, each of the multiple different brain emulation sub-networks 210 can be selected based on a portion of the brain 104 that is known to correspond to a particular function. For example, a brain emulation sub-network can be selected to process video data based on a portion of the brain 104 that is known to correspond to the visual cortex of the biological organism 106. Selection of the different brain emulation sub-networks 210 can be performed, for example, using black-box optimization techniques (e.g., Google Vizier™ as described in Proceedings of the 23rd ACM SIGKDD International Conference on Knowledge Discovery and Data Mining August 2017 Pages 1487-1495, https://doi.org/10.1145/3097983.3098043).

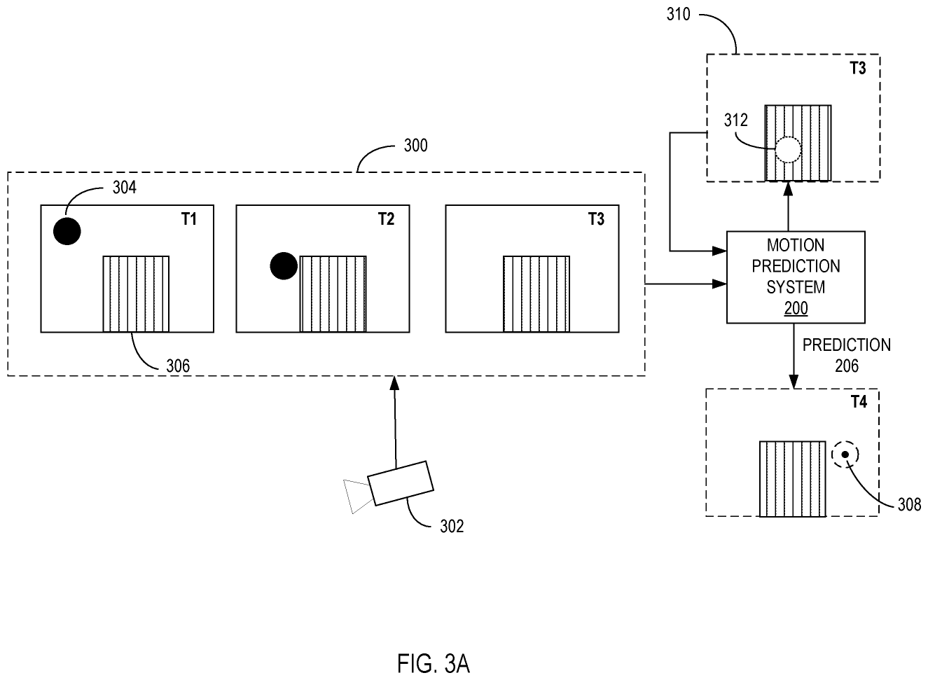

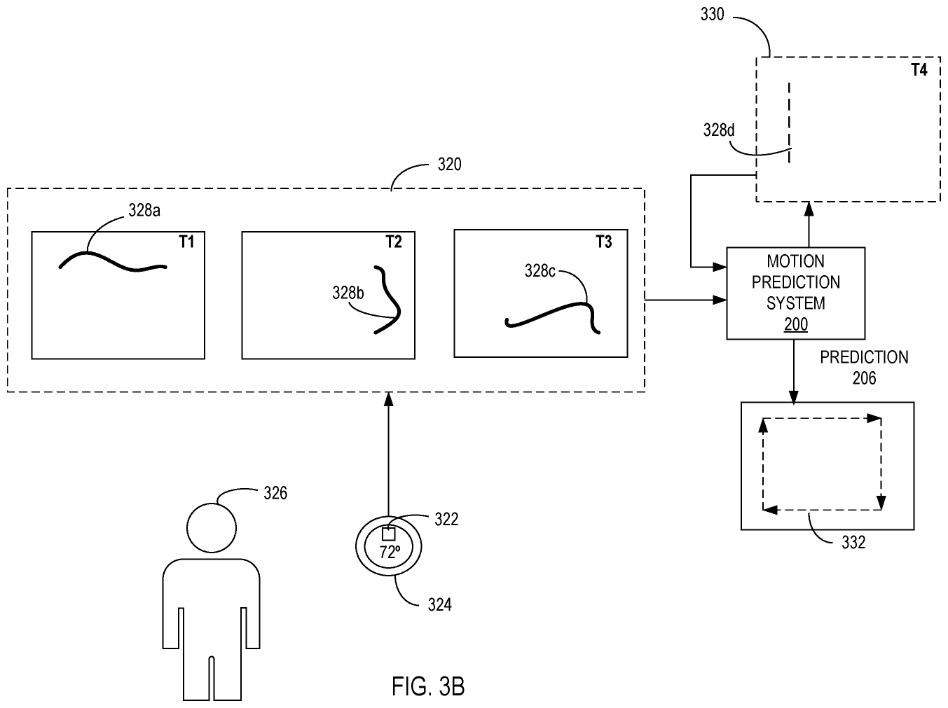

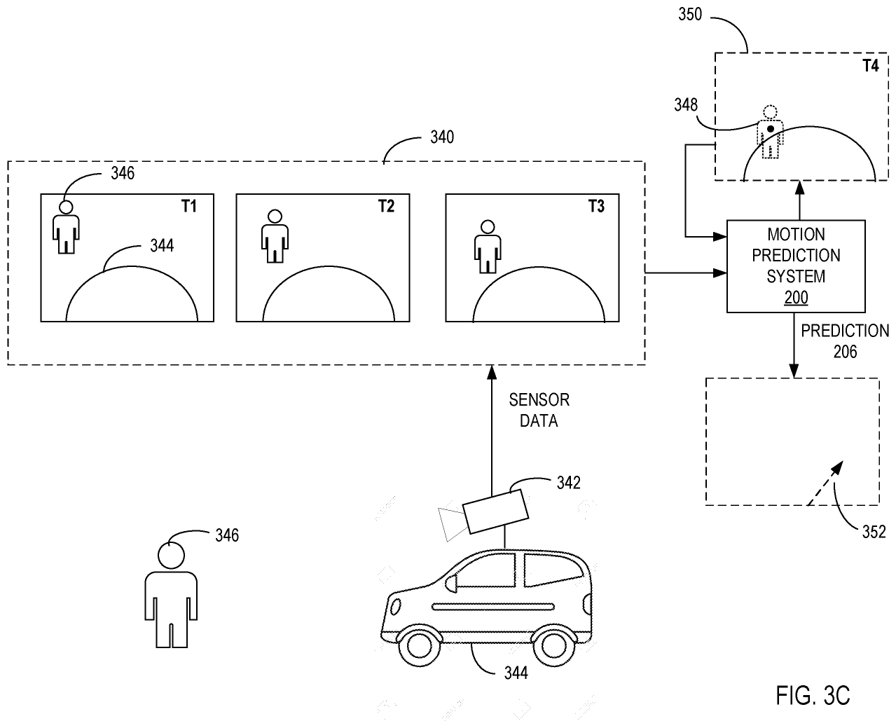

FIGS. 3A-3C show examples of sensor data capturing motion of objects. In one example, as depicted in FIG. 3A, sensor data 300 captured over multiple time steps T1-T3 (e.g., multiple frames of a video) by a sensor 302 (e.g., a camera, LiDAR system, etc.) depicting an object of interest 304 (ball) in motion. At time step T3, the object 304 is obscured by a different object 306 (block) such that the sensor data 300 does not explicitly capture a position of the object 304 within the sensor data 300. The sensor data 300 is provided as input to the motion prediction system 200, where a prediction output from the system (e.g., a prediction 206) can be a next location 308 of the object 304 at a future time step T4 (e.g., as indicated by a point/pixel at a center point of the object). As described above, the motion prediction neural network can process the sensor data as follows: sensor data (e.g., a first frame of a video) at time step T1 can be processed by the motion prediction neural network to generate a first intermediate output including identifying the object 304 within the sensor data at T1. The first intermediate output can be provided as input to the motion prediction neural network along with sensor data for time step T2. A second intermediate output including identifying the object 304 within the sensor data at T2 generated by the motion prediction neural network along with the sensor data at time step T3 can be utilized to generate an intermediate output 312 including a predicted location 312 (i.e., utilizing a brain emulation sub-network specified for object permanence and/or motion prediction) of the object 304 at T3 (where the object is obscured), and provide the output 312 as input back to the motion prediction neural network to generate a prediction, e.g., prediction 206, that is a future location of the object 304 at a time step T4.

In another example, as depicted in FIG. 3B, sensor data 320 captured over multiple time steps T1-T3 (e.g., multiple radar spectrograms, multiple sets of point cloud data) by a sensor 322 on a device 324 (e.g., a microarray of radar sensors on a smart thermostat) depicting a gesture performed by a person 326. At each of the time steps T1-T3, different portions 328a, 328b, and 328c of the gesture are captured. As depicted, the recorded portions of the gesture can be incomplete, noisy, or include variations from a nominal gesture (e.g., the lines are wavy and/or incomplete). The sensor data 320 is provided as input to the motion prediction system 200, where a prediction (e.g., prediction 206) can be a next portion 328d of the gesture at a time step T4. As described above, the motion prediction neural network can process the sensor data as follows: sensor data (e.g., a first frame of a video) at time step T1 can be processed by the motion prediction neural network to generate a first intermediate output including identifying a first portion 328a of a gesture (i.e., utilizing a brain emulation sub-networks selected to identify curves/lines) within the sensor data at T1. The first intermediate output can be provided as input to the motion prediction neural network along with sensor data for time step T2. A second intermediate output including identifying a second portion 328b of the gesture within the sensor data at T2 generated by the motion prediction neural network along with the sensor data at time step T3 can be utilized to generate an intermediate output 312 including a predicted next portion 328d of the gesture at a future time step T4 (i.e., utilizing a brain emulation sub-network selected for motion prediction), and provide the first output 330 as input back to the motion prediction neural network (or to an output sub-network) to generate a second output, e.g., a prediction 206 that is a classification of the gesture 332 performed across time steps T1-T3.

FIG. 3C depicts sensor data 340 captured over multiple time steps T1-T3 (e.g., multiple frames of a video, multiple set of point cloud data) by a sensor 342 onboard a vehicle 344 (e.g., a semi or fully-autonomous vehicle or drone) depicting an object of interest 346 (e.g., a person) in motion relative to another different object (e.g., a front end of the vehicle 344) which may also be in motion. In this scenario, the vehicle 344 can include an onboard camera and/or LiDAR system to capture the sensor data 340 to provide to the motion prediction system 200 to generate predictions about an object 346 surrounding the vehicle, e.g., to avoid collisions. The sensor data 340 is provided as input to the motion prediction system 200, where a prediction (e.g., prediction 206) can be a next location 348 of the object 346 (e.g., as indicated by a point/pixel at a center point of the object). As described above, the motion prediction neural network can process the sensor data as follows: sensor data (e.g., a first frame of a video or point cloud data from a LiDAR system) at time step T1 can be processed by the motion prediction neural network to generate a first intermediate output including identifying a person within the sensor data at T1 (i.e., utilizing a brain emulation sub-network selected for object recognition). The first intermediate output can be provided as input to the motion prediction neural network along with sensor data for time step T2. A second intermediate output including identifying the person within the sensor data at T2 generated by the motion prediction neural network (and/or an output sub-network) can include a first output 350 including a next location 348 of the object at a future time step T4 (i.e., utilizing a brain emulation sub-network selected for motion prediction), and provide the first output 350 as input back to the motion prediction system 200 to generate a second output, e.g., prediction 206 that is a course correction 352 for the vehicle 344 to avoid a collision with the object 346 (i.e., utilizing a brain emulation sub-network selected for association).

FIG. 4 shows an example architecture selection system 400. The architecture selection system 400 is an example of a system implemented as computer programs on one or more computers in one or more locations in which the systems, components, and techniques described below are implemented.

The system 400 is configured to search a space of possible neural network architectures to identify the neural network architecture of a brain emulation neural network 108 to be included in a motion prediction neural network that processes sensor data, e.g., as described with reference to FIGS. 2A-2C. The system 400 seeds the search through the space of possible neural network architectures using a synaptic connectivity graph 102 representing synaptic connectivity in the brain of a biological organism. The synaptic connectivity graph 102 may be derived directly from a synaptic resolution image of the brain of a biological organism, e.g., as described with reference to FIG. 1. In some cases, the synaptic connectivity graph 102 may be a sub-graph of a larger graph derived from a synaptic resolution image of a brain, e.g., a sub-graph that includes neurons of a particular type, e.g., visual neurons, association neurons, motion prediction neurons, object permanence neurons, etc.

In some implementations, the system 400 is configured to search a space of possible neural network architectures to identify multiple neural network architectures for multiple brain emulation neural networks 108 to be included in a motion prediction neural network that processes sensor data, where each of the multiple neural network architectures for respective brain emulation neural networks can be selected to perform a particular task, e.g., object recognition, motion prediction, etc. In other words, the processes described herein with reference to system 400 with respect to determining a single neural network architecture for a brain emulation neural network 108 can be applied to a process to determine multiple neural network architectures to respective brain emulation neural networks 108.

The system 400 includes a graph generation engine 402, an architecture mapping engine 404, a training engine 406, and a selection engine 408, each of which will be described in more detail next.

The graph generation engine 402 is configured to process the synaptic connectivity graph 102 to generate multiple “brain emulation” graphs 410, where each brain emulation graph is defined by a set of nodes and a set of edges, such that each edge connects a pair of nodes. The graph generation engine 402 may generate the brain emulation graphs 410 from the synaptic connectivity graph 102 using any of a variety of techniques. A few examples follow.

In one example, the graph generation engine 402 may generate the brain emulation graphs 410 at each of multiple iterations by processing the synaptic connectivity graph 102 in accordance with current values of a set of graph generation parameters. The current values of the graph generation parameters may specify (transformation) operations to be applied to an adjacency matrix representing the synaptic connectivity graph 102 to generate a respective adjacency matrix representing each of the brain emulation graphs 410. The operations to be applied to the adjacency matrices representing each of the synaptic connectivity graphs may include, e.g., filtering operations, cropping operations, or both. The brain emulation graphs 410 may each be defined by the results of applying the operations specified by the current values of the graph generation parameters to the respective adjacency matrix representing the synaptic connectivity graph 102.

The graph generation engine 402 may apply a filtering operation to the adjacency matrices representing the synaptic connectivity graph 102, e.g., by convolving a filtering kernel with the respective adjacency matrix representing the synaptic connectivity graph. The filtering kernel may be defined by a two-dimensional matrix, where the components of the matrix are specified by the graph generation parameters. Applying a filtering operation to an adjacency matrix representing the synaptic connectivity graph 102 may have the effect of adding edges to the synaptic connectivity graph 102, removing edges from the synaptic connectivity graph 102, or both.

The graph generation engine 402 may apply a cropping operation to the adjacency matrices representing the synaptic connectivity graph 102, where the cropping operation replaces an adjacency matrix representing the synaptic connectivity graph 102 with a corresponding adjacency matrix representing a sub-graph of the synaptic connectivity graph 102. The cropping operation may specify a sub-graph of synaptic connectivity graph 102, e.g., by specifying a proper subset of the rows and a proper subset of the columns of the adjacency matrix representing the synaptic connectivity graph 102 that define a sub-matrix of the adjacency matrix. The sub-graph may include: (i) each edge specified by the sub-matrix, and (ii) each node that is connected by an edge specified by the sub-matrix.

At each iteration, the system 400 determines performance measures 412 corresponding to each of the brain emulation graphs 410 generated at the iteration, and the system 400 updates the current values of the graph generation parameters for each of the brain emulation graphs 410 to encourage the generation of brain emulation graphs 410 with higher performance measures 412. The performance measures 412 for each of the brain emulation graphs 410 characterize the performance of a motion prediction neural network that can include multiple brain emulation neural networks each having a respective architecture specified by the brain emulation graphs 410 for performing a respective task, e.g., at processing sensor data to perform object recognition, motion prediction, etc. Determining performance measures 412 for brain emulation graphs 410 will be described in more detail below. The system 400 may use any appropriate optimization technique to update the current values of the graph generation parameters, e.g., a “black-box” optimization technique that does not rely on computing gradients of the operations performed by the graph generation engine 402. Examples of black-box optimization techniques which may be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 402 may generate the brain emulation graphs 410 by “evolving” a population (i.e., a set) of graphs derived from the synaptic connectivity graph 102 over multiple iterations. The graph generation engine 402 may initialize the population of graphs, e.g., by “mutating” multiple copies of the synaptic connectivity graph 102. Mutating a graph refers to making a random change to the graph, e.g., by randomly adding or removing edges or nodes from the graph. After initializing the population of graphs, the graph generation engine 402 may generate a respective brain emulation graph at each of multiple iterations by, at each iteration, selecting a graph from the population of graphs derived from the synaptic connectivity graph and mutating the selected graph to generate the brain emulation graphs 410. The graph generation engine 402 may determine performance measures 412 for the brain emulation graphs 410, and use the performance measures to determine whether the brain emulation graphs 410 are added to the current population of graphs.

In some implementations, each edge of the synaptic connectivity graph may be associated with a weight value that is determined from the synaptic resolution image of the brain, as described above. Each brain emulation graph may inherit the weight values associated with the edges of the synaptic connectivity graph. For example, each edge in the brain emulation graph that corresponds to an edge in the synaptic connectivity graph may be associated with the same weight value as the corresponding edge in the synaptic connectivity graph. Edges in the brain emulation graph that do not correspond to edges in the synaptic connectivity graph may be associated with default or randomly initialized weight values.

In another example, the graph generation engine 402 can generate each brain emulation graph 410 as a sub-graph of the synaptic connectivity graph 102. For example, the graph generation engine 402 can randomly select sub-graphs, e.g., by randomly selecting a proper subset of the rows and a proper subset of the columns of the adjacency matrix representing the synaptic connectivity graph that define a sub-matrix of the adjacency matrix. The sub-graph may include: (i) each edge specified by the sub-matrix, and (ii) each node that is connected by an edge specified by the sub-matrix.

The architecture mapping engine 404 processes each brain emulation graph 410 to generate a corresponding brain emulation neural network architecture 414. The architecture mapping engine 404 may use the brain emulation graphs 410 derived from the synaptic connectivity graph 102 to specify the brain emulation neural network architectures 414 in any of a variety of ways. For example, the architecture mapping engine may map each node in the brain emulation graph 410 to a corresponding: (i) artificial neuron, (ii) artificial neural network layer, or (iii) group of artificial neural network layers in the brain emulation neural network architecture, as will be described in more detail next.

In one example, each of the brain emulation neural network architectures may include: (i) a respective artificial neuron corresponding to each node in the brain emulation graph 410, and (ii) a respective connection corresponding to each edge in the brain emulation graph 410. In this example, the brain emulation graph may be a directed graph, and an edge that points from a first node to a second node in the brain emulation graph may specify a connection pointing from a corresponding first artificial neuron to a corresponding second artificial neuron in the brain emulation neural network architecture. The connection pointing from the first artificial neuron to the second artificial neuron may indicate that the output of the first artificial neuron should be provided as an input to the second artificial neuron. Each connection in the brain emulation neural network architecture may be associated with a weight value, e.g., that is specified by the weight value associated with the corresponding edge in the brain emulation graph. An artificial neuron may refer to a component of the brain emulation neural network architecture that is configured to receive one or more inputs (e.g., from one or more other artificial neurons), and to process the inputs to generate an output. The inputs to an artificial neuron and the output generated by the artificial neuron may be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the brain emulation graph 410 may be an undirected graph, and the architecture mapping engine 404 may map an edge that connects a first node to a second node in the brain emulation graph 410 to two connections between a corresponding first artificial neuron and a corresponding second artificial neuron in the brain emulation neural network architecture. In particular, the architecture mapping engine 404 may map the edge to: (i) a first connection pointing from the first artificial neuron to the second artificial neuron, and (ii) a second connection pointing from the second artificial neuron to the first artificial neuron.

In another example, the brain emulation graph 410 may be an undirected graph, and the architecture mapping engine may map an edge that connects a first node to a second node in the brain emulation graph 410 to one connection between a corresponding first artificial neuron and a corresponding second artificial neuron in the brain emulation neural network architecture. The architecture mapping engine may determine the direction of the connection between the first artificial neuron and the second artificial neuron, e.g., by randomly sampling the direction in accordance with a probability distribution over the set of two possible directions.

In another example, the brain emulation neural network architectures may include: (i) a respective artificial neural network layer corresponding to each node in the brain emulation graph 410, and (ii) a respective connection corresponding to each edge in the brain emulation graph 410. In this example, a connection pointing from a first layer to a second layer may indicate that the output of the first layer should be provided as an input to the second layer. An artificial neural network layer may refer to a collection of artificial neurons, and the inputs to a layer and the output generated by the layer may be represented as ordered collections of numerical values (e.g., tensors of numerical values). In one example, the brain emulation neural network architecture may include a respective convolutional neural network layer corresponding to each node in the brain emulation graph 410, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each connection may be specified by the weight value associated with the corresponding edge in the brain emulation graph), h_{θ}(⋅) represents the operation of applying one or more convolutional kernels to an input to generate a corresponding output, and σ(⋅) is a non-linear activation function that is applied element-wise to each component of its input. In this example, each convolutional kernel may be represented as an array of numerical values, e.g., where each component of the array is randomly sampled from a predetermined probability distribution, e.g., a standard Normal probability distribution.

In another example, the architecture mapping engine may determine that the brain emulation neural network architectures include: (i) a respective group of artificial neural network layers corresponding to each node in the brain emulation graph 410, and (ii) a respective connection corresponding to each edge in the brain emulation graph 410. The layers in a group of artificial neural network layers corresponding to a node in the brain emulation graph 410 may be connected, e.g., as a linear sequence of layers, or in any other appropriate manner.

The brain emulation neural network architecture 414 may include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network. An output artificial neural neuron may refer to an artificial neuron that generates an output which is considered part of the overall output generated by the brain emulation neural network. The architecture mapping engine may add artificial neurons to the brain emulation neural network architecture in addition to those specified by nodes in the synaptic connectivity graph, and designate the added neurons as input artificial neurons and output artificial neurons. For example, for a brain emulation neural network that is configured to process an input including a 100×100 matrix to generate an output that includes a 1000-dimensional vector, the architecture mapping engine may add 10,000 (=100×100) input artificial neurons and 1000 output artificial neurons to the architecture. Input and output artificial neurons that are added to the brain emulation neural network architecture may be connected to the other neurons in the brain emulation neural n network architecture in any of a variety of ways. For example, the input and output artificial neurons may be densely connected to every other neuron in the brain emulation neural network architecture.

The training engine 406 instantiates multiple motion prediction neural networks 416 that each include one or more brain emulation sub-networks having corresponding brain emulation neural network architectures 414. Examples of motion prediction neural networks that include brain emulation sub-networks are described in more detail with reference to FIGS. 2A-2C. Each motion prediction neural network 416 is configured to perform one or more of a sensor data processing task, motion processing task, etc., for example, a prediction task or an auto-encoding task. In a prediction task, the motion prediction neural network is configured to process sensor data to generate a prediction characterizing the sensor data, e.g., a segmentation, classification, or regression prediction, as described above. In an auto-encoding task, the motion prediction neural network is configured to process sensor data to generate a “reconstruction” (i.e., estimate) of the sensor data, e.g., a “reconstruction” of a radar spectrogram, point cloud data, or an image. In some implementations, the motion prediction neural network is configured to perform an auto-encoding task including reconstructing and de-noising input sensor data, e.g., noisy radar data.

The training engine 406 is configured to train each motion prediction neural network 416 to perform a motion processing task over multiple training iterations. Training a motion prediction neural network that includes one or more brain emulation sub-networks to perform a prediction task is described with reference to FIGS. 2A-2C. Training a motion prediction neural network to perform an auto-encoding task proceeds similarly, except that the objective function being optimized measures an error between: (i) sensor data, and (ii) a reconstruction of the sensor data that is generated by the motion prediction neural network.

The training engine 406 determines a respective performance measures 412 of motion prediction neural network on the motion processing task. For example, to determine the performance measure, the training engine 406 may obtain “validation” sets of sensor data that were not used during training of the motion prediction neural network, and process each of these sets of sensor data using the trained motion prediction neural network to generate a corresponding output. The training engine 406 may then determine the performance measures 412 based on the respective error between: (i) the output generated by the motion prediction neural networks for the sensor data, and (ii) a target output for the sensor data, for each set of sensor data in the validation set. For a prediction task, the target output for sensor data may be, e.g., a ground-truth segmentation, classification, or regression output. For an auto-encoding task, the target output for sensor data may be the sensor data itself. The training engine 406 may determine the performance measure 412, e.g., as the average error or the maximum error over the sets of sensor data in the validation set.

The selection engine 408 uses the performance measures 412 to select one or more output brain emulation neural networks 108. For example, the selection engine 308 can identify the motion prediction neural network 416 associated with the highest performance measure, and output the one or more brain emulation neural networks that are included in the identified motion prediction neural network.

If the performance measures 412 characterize the performance of the motion prediction neural networks 416 on a prediction task, then the architecture selection system 400 may generate one or more brain emulation neural networks 108 that are each tuned for effective performance on the specific prediction task, e.g., object identification, motion prediction, etc. If, on the other hand, the performance measures 412 characterize the performance of the motion prediction neural networks 416 on an auto-encoding task, then the architecture selection system 400 may generate one or more brain emulation neural networks 108 that are each generally effective for a variety of prediction tasks that involve processing sensor data, e.g., processing noisy radar data.

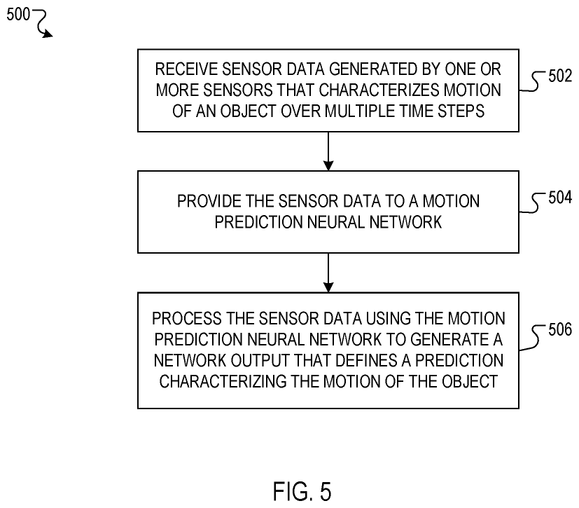

FIG. 5 is a flow diagram of an example process 500 for processing sensor data using a motion prediction neural network to generate a prediction characterizing the sensor data. For convenience, the process 500 will be described as being performed by a system of one or more computers located in one or more locations. For example, a motion prediction system, e.g., the motion prediction system 200 of FIGS. 2A-2C, appropriately programmed in accordance with this specification, can perform the process 500.

The system receives sensor data captured by one or more sensors that characterizes motion of an object over multiple time steps (502). In some implementations, the system receives sensor data captured over multiple time steps by a sensor of a device (e.g., a radar microarray located on a smart appliance, a camera on a vehicle or drone, etc.) of an object in motion, e.g., a gesture being performed by a user, a pedestrian walking nearby a vehicle in motion, etc.

The system provides the sensor data to a motion prediction neural network (504). In some implementations, as described with reference to FIGS. 2A-2C, the system performs pre-processing on the sensor depending in part on a type of sensor data that is input to the motion prediction neural network. For example, pre-processing of video data can include a color correction/gain adjustment to enhance a contrast between an object of interest and a scene. In another example, pre-processing of radar data can include radar digital signal processing techniques to reduce noise in the sensor data. In another example, pre-processing of point cloud data (e.g., LiDAR data) can include generating a spectrogram, e.g., a 4D or 5D spectrogram of the point cloud data.

In some implementations, the system provides the sensor data to an input sub-network to generate an embedding of the sensor data, e.g., a matrix, tensor, or vector of numerical values.

The system processes the sensor data using the motion prediction neural network to generate a network output that defines a prediction characterizing the motion of the object (506). The values of at least some of the brain emulation sub-network parameters may be determined before the motion prediction neural network is trained and not be adjusted during training of the motion prediction neural network. The brain emulation sub-network has a neural network architecture that is specified by a brain emulation graph, where the brain emulation graph is generated based on a synaptic connectivity graph representing synaptic connectivity between neurons in a brain of a biological organism. The synaptic connectivity graph specifies a set of nodes and a set of edges, where each edge connects a pair of nodes, each node corresponds to a respective neuron in the brain of the biological organism. Each edge connecting a pair of nodes in the synaptic connectivity graph may correspond to a synaptic connection between a pair of neurons in the brain of the biological organism.

In some implementations, the system processes the alternative representation of the sensor data using an output sub-network of the motion prediction neural network to generate a prediction characterizing the sensor data. The prediction may be, e.g., a next location of the object at a future time step, a classification of a gesture (or partial gesture) performed by a user, a course correction/hazard avoidance measure, etc. In some implementations, the system processes the alternative representation of the sensor data to generate multiple predictions, for example, an object detection prediction, a course correction prediction, and a future motion prediction for an object in motion.

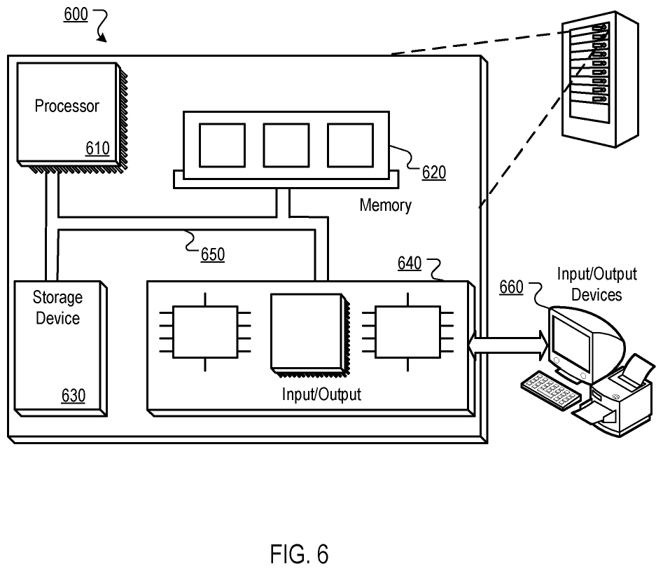

FIG. 6 is a block diagram of an example computer system 600 that can be used to perform operations described previously. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (for example, a cloud storage device), or some other large capacity storage device.

The input/output device 640 provides input/output operations for the system 600. In one implementation, the input/output device 640 can include one or more network interface devices, for example, an Ethernet card, a serial communication device, for example, and RS-232 port, and/or a wireless interface device, for example, and 802.11 card. In another implementation, the input/output device 640 can include driver devices configured to receive input data and send output data to other input/output devices, for example, keyboard, printer and display devices 660. Other implementations, however, can also be used, such as mobile computing devices, mobile communication devices, and set-top box television client devices.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
receiving sensor data generated by one or more sensors that characterizes motion of an object over a plurality of time steps;
providing the sensor data characterizing the motion of the object to a motion prediction neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the sensor data characterizing the motion of the object using the motion prediction neural network having the brain emulation sub-network to generate a network output that defines a prediction characterizing the motion of the object.

2. The method of claim 1, wherein the motion prediction neural network further comprises an input sub-network, wherein the input sub-network is configured to process the sensor data to generate an embedding of the sensor data, wherein the brain emulation sub-network is configured to process the embedding of the sensor data that is generated by the input sub-network.

3. The method of claim 1, wherein the motion prediction neural network further comprises an output sub-network, wherein the output sub-network is configured to process an output generated by the brain emulation sub-network to generate the prediction characterizing the motion of the object.

4. The method of claim 1, wherein the prediction characterizing the motion of the object comprises a tracking prediction that tracks a location of the object over the plurality of time steps.

5. The method of claim 1, wherein the prediction characterizing the motion of the object predicts a future motion of the object at one or more future time steps.

6. The method of claim 5, wherein the prediction characterizing the motion of the object predicts a future location of the object at a future time step.

7. The method of claim 5, wherein the prediction characterizing the motion of the object predicts whether the object will collide with another object at a future time step.

8. The method of claim 1, wherein the sensor data characterizes motion of a person over the plurality of time steps.

9. The method of claim 8, wherein the prediction characterizing the motion of the object is a gesture recognition prediction that predicts one or more gestures made by the person.

10. The method of claim 1, wherein processing the sensor data using the motion prediction neural network having the brain emulation sub-network is performed by an onboard computer system of a device.

11. The method of claim 10, further comprising, providing the prediction characterizing the motion of the object to a control unit of the device, wherein the control unit of the device generates control signals for operation of the device.

12. The method of claim 1, wherein the sensor data comprises video data including a plurality of frames characterizing the motion of the object over the plurality of time steps.

13. The method of claim 12, wherein the prediction characterizing the motion of the object over the plurality of time steps is a tracking prediction that comprises data defining, for each frame, a predicted location of the object in the frame.

14. The method of claim 12, further comprising a pre-processing step prior to providing the video data to the motion prediction neural network, wherein the pre-processing step comprises a color correction to each of the plurality of frames of the video data.

15. The method of claim 1, wherein the sensor data comprises spectrograms generated utilizing a radar microarray of sensors or light detector and ranging (LiDAR) techniques.

16. The method of claim 1, wherein specifying the brain emulation sub-network architecture further comprises, for each pair of artificial neurons in the brain emulation sub-network that are connected by a respective connection:
instantiating a weight value for the connection based on a proximity of a pair of biological neurons in the brain of the biological organism that correspond to the pair of artificial neurons in the brain emulation sub-network, wherein the weight values of the brain emulation sub-network are static during training of the motion prediction neural network.

17. The method of claim 1, wherein specifying the brain emulation sub-network architecture further comprises:
specifying a first brain emulation neural sub-network selected to perform contour detection to generate a first alternative representation of the sensor data; and
specifying a second brain emulation neural sub-network selected to perform motion prediction to generate a second alternative representation of the sensor data.

18. The method of claim 1, wherein the motion prediction neural network is a recurrent neural network and wherein processing the sensor data characterizing the motion of the object using the motion prediction neural network comprises, for each time step after a first time step of the plurality of time steps:
processing sensor data for the time step and data generated by the motion prediction neural network for a previous time step to update a hidden state of the recurrent neural network.

19. A system comprising:
one or more computers; and
one or more storage devices communicatively coupled to the one or more computers, wherein the one or more storage devices store instructions that, when executed by the one or more computers, cause the one or more computers to perform operation comprising:
receiving sensor data generated by one or more sensors that characterizes motion of an object over a plurality of time steps;
providing the sensor data characterizing the motion of the object to a motion prediction neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the sensor data characterizing the motion of the object using the motion prediction neural network having the brain emulation sub-network to generate a network output that defines a prediction characterizing the motion of the object.

20. One or more non-transitory computer storage media storing instructions that when executed by one or more computers cause the one or more computers to perform operations comprising:
receiving sensor data generated by one or more sensors that characterizes motion of an object over a plurality of time steps;
providing the sensor data characterizing the motion of the object to a motion prediction neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the sensor data characterizing the motion of the object using the motion prediction neural network having the brain emulation sub-network to generate a network output that defines a prediction characterizing the motion of the object.
